(19) United States
(12) Patent Application Publication
(10) Pub. No.: US 2025/0052032 A1
(43) Pub. Date: Feb. 13, 2025

(54) CONTROLLING MOVEMENT OF A TRACK-MOUNTED VEHICLE

(71) Applicant: SANDVIK MINING AND CONSTRUCTION OY, Tampere (FI)

(72) Inventors: Toni PELTOMAA, Tampere (FI); Severi EEROLA, Tampere (FI); Petri SUOMI, Tampere (FI); Jari PUONTI, Tampere (FI); Mika SELIN, Tampere (FI); Mika SAHLMAN, Tampere (FI); Satu SORANUMMI, Tampere (FI); Jennifer BISHOP, Tampere (FI); Riku HELLEVAARA, Tampere (FI); Ryan HOPE, Tampere (FI)

(21) Appl. No.: 18/232,934

(22) Filed: Aug. 11, 2023

(51) Int. Cl. E02F 9/20

(52) U.S. Cl. CPC E02F 9/2045; E02F 9/205

(57) ABSTRACT

An apparatus for controlling a track-mounted vehicle includes at least one processor, and at least one memory including computer program code. The at least one memory and the computer program code are configured to, with the at least one processor, cause the apparatus at least to: obtain information on a path to be followed by the track-mounted vehicle; obtain information on at least one characteristic affecting movement control of the track-mounted vehicle; determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path.

### TECHNICAL FIELD

Various example embodiments generally relate to the field of controlling track-mounted vehicles. Some example embodiments relate to determining a position of a control point for controlling movement of a track-mounted vehicle along a path.

### BACKGROUND

In various fields of technology, such as for example mining, it may be desired to automatically control movement of vehicles. For example, it may be desired to control movement of a vehicle along a desired path. Track-mounted vehicles of different types may be configured for different purposes, such as for example rock drilling, loading, mesh installation, bolting, or the like, and they may be equipped with respective tools.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, an apparatus for controlling a track-mounted vehicle is disclosed. The apparatus may comprise: at least one processor; and at least one memory including computer program code, the at least one memory and the computer program code configured to, with the at least one processor, cause the apparatus at least to: obtain information on a path to be followed by the track-mounted vehicle: obtain information on at least one characteristic affecting movement control of the track-mounted vehicle: determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path.

According to a second aspect, a track-mounted vehicle is disclosed. The track-mounted vehicle may be configured to: obtain information on a path to be followed by the track-mounted vehicle: obtain information on at least one characteristic affecting movement control of the track-mounted vehicle: determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path.

According to a third aspect, a method for controlling a track-mounted vehicle is disclosed. The method may comprise: obtaining information on a path to be followed by the track-mounted vehicle: obtaining information on at least one characteristic affecting movement control of the track-mounted vehicle: determining a position of a control point in relation to the track-mounted vehicle based on the at least one characteristic; and controlling movement of the track-mounted vehicle based on the path and the control point, wherein the control point is configured to be aligned with the path to cause the track-mounted vehicle to follow the path.

According to a fourth aspect, an apparatus is disclosed. The apparatus may comprise: means for obtaining information on a path to be followed by the track-mounted vehicle: means for obtaining information on at least one characteristic affecting movement control of the track-mounted vehicle: means for determining a position of a control point in relation to the track-mounted vehicle based on the at least one characteristic; and means for controlling movement of the track-mounted vehicle based on the path and the control point, wherein the control point is configured to be aligned with the path to cause the track-mounted vehicle to follow the path.

According to a fifth aspect, a computer program, a computer program product, or a (non-transitory) computer-readable medium is disclosed. The computer program, computer program product, or (non-transitory) computer-readable medium may comprise program instructions which, when executed by an apparatus, cause the apparatus at least to: obtain information on a path to be followed by the track-mounted vehicle: obtain information on at least one characteristic affecting movement control of the track-mounted vehicle: determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path.

Example embodiments of the above aspects are described in the claims, the description, and/or the drawings. According to some aspects, there is provided the subject matter of the independent claims. Some further aspects are defined in the dependent claims. Many of the attendant features will be more readily appreciated as they become better understood by reference to the following description considered in connection with the accompanying drawings.

### BRIEF DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a track-mounted vehicle;

FIG. 2 illustrates an example of a track-mounted vehicle communicatively coupled to a remote control device:

FIG. 3 illustrates an example of a flow chart for controlling a track-mounted vehicle:

FIG. 4 illustrates an example of controlling a track-mounted vehicle to follow a path:

FIG. 5 illustrates an example of adjusting a position of a control point in relation to a track-mounted vehicle:

FIG. 6 illustrates an example of deviations of the position of a control point from a desired path:

FIG. 7 illustrates an example of deviation of the heading of a track-mounted vehicle from a trajectory of a control point of the track-mounted vehicle:

FIG. 8 illustrates an example of an apparatus configured to practise one or more example embodiments; and

FIG. 9 illustrates an example of a method for controlling a track-mounted vehicle; Like references are used to designate like parts in the accompanying drawings.

### DESCRIPTION

Reference will now be made to embodiments, examples of which are illustrated in the accompanying drawings. The description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

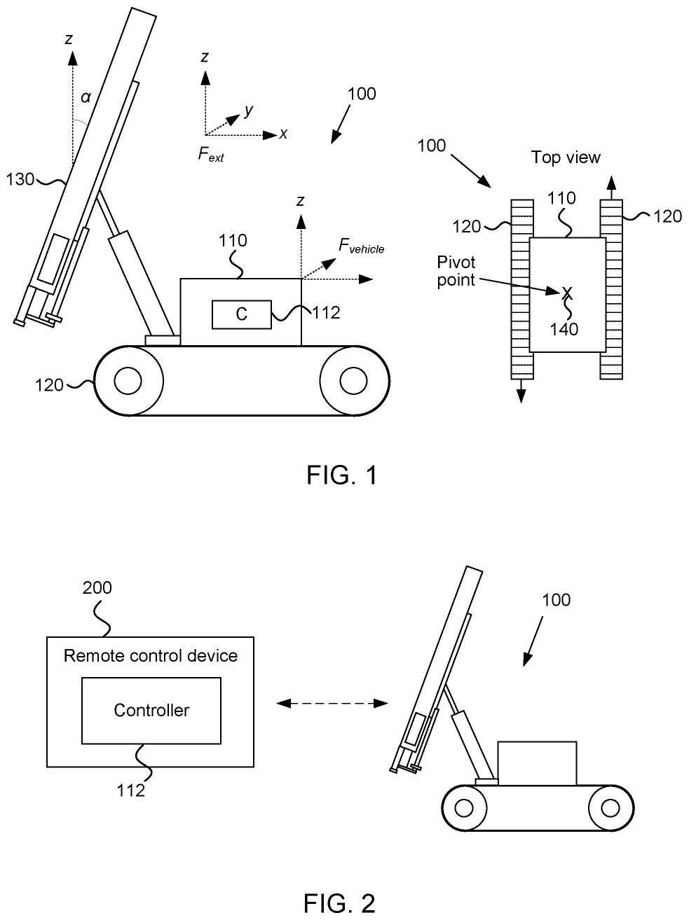

FIG. 1 illustrates an example of a track-mounted vehicle. Even though track-mounted vehicle 100 is illustrated as a surface drill rig, example embodiments of the present disclosure may be also applied to other type of track-mounted vehicles, track-mounted machines, or track-mounted equipment, such as for example underground drill rigs, mining trucks, mining loaders, bolter miners, road headers, or multitaskers.

Track-mounted vehicle 100 may be an automated track-mounted vehicle or a semi-autonomous track-mounted vehicle, for example a remote-controlled track-mounted vehicle. An automated track-mounted vehicle may be equipped with tools configured for a certain task, for example drilling, loading, or bolting. An automated track-mounted vehicle operating in an automatic mode may be configured to, for example, receive a task to be performed, perceive the environment of the automated track-mounted vehicle, and autonomously perform the task while taking the environment into account. An automated track-mounted vehicle operating in an automatic mode may be configured to operate independently but may be taken under external control by a human operator at certain operation areas or conditions, such as during states of emergencies.

In the example of FIG. 1, track-mounted vehicle 100 comprises a drill rig. The drill rig may comprise a movable carrier 110 and a mast 130. Track-mounted vehicle 100 may comprise controller 112. The position and/or orientation of mast 130 may be controlled by controller 112, for example to place mast 130 in a suitable position/orientation for performing a task or for moving the drill rig for performing a task at another location. For example, the inclination angle (a) of mast 130 may be adjusted. The inclination angle may comprise an angle between mast 130 and a vertical axis (z). The vertical axis (z) may be parallel to the vector of gravity. It is however noted that any other suitable measure of mast inclination may be applied. Position/orientation of mast 130 may affect characteristics of controlling movement of the drill rig. for example because of different weight distribution.

The drill rig may comprise tracks 120, which may be connected to movable carrier 110. Movable carrier 110 may comprise equipment for moving or stabilising the drill rig, such as for example a motor, wheels, or stabilizer jacks. Even though two tracks 120 have been illustrated in FIG. 1, the drill rig may in general comprise a plurality (e.g., two, four . . . ) of tracks 120. Track-mounted vehicle 100 may comprise one or more of the parts described above, or other tool(s) or equipment relevant for other type of track-mounted vehicles. For example, track-mounted vehicle 100 may be configured with one or more booms instead of mast 130 and the example embodiments related to mast 130 may be alternatively applied to the boom(s).

Track-mounted vehicle 100 may comprise a pivot point 140. Pivot point 140 may correspond to the pivot point of track-mounted vehicle 100 without non-rotational transition of track-mounted vehicle 100 in a coordinate system, for example an external coordinate frame (Fₑₓₜ), which may be stationary with respect to the ground. Hence, pivot point 140 may comprise a point of track-mounted vehicle 100, around which track-mounted vehicle 100 rotates when track-mounted vehicle 100 is not moving in a forward or backward direction. For example, pivot point 140 may be stationary with respect to the external coordinate frame when rotating track-mounted vehicle 100 by moving tracks 120 in opposite directions with the same speed. Pivot point 140 may be defined in a coordinate frame of track-mounted vehicle 100 (F_{vehicle}). This coordinate frame may be stationary with respect to track-mounted vehicle 100.

Controller 112 may be provided as a software application residing on a memory and being executable by a processor. An example of an apparatus suitable for implementing controller 112 is provided in FIG. 8. Controller 112 may comprise, or be communicatively coupled to, various functions, blocks, or applications for implementing functionality of controller 112. For example, controller 112 may comprise or be communicatively coupled to a data management server, which may be configured to store information on functions to be performed by track-mounted vehicle 100, a path to be followed, tunnel lines, point cloud or mesh presentations of tunnel lines or profiles, a mine map point cloud, or the like: or in general representation(s) of the working environment of track-mounted vehicle 100.

Controller 112 may comprise a navigation application configured to control, or enable a human operator to control, navigation of track-mounted vehicle 100, for example to move track-mounted vehicle 100 via a desired path, for example to a desired position for performing a function. A position of track-mounted vehicle 100 may be referred to as a navigation position. The navigation position may be provided with respect to the external coordinate frame (Fₑₓₜ).

Controller 112 may be alternatively located external to track-mounted vehicle 100 and configured to remotely control track-mounted vehicle 100. For example, controller 112 may be provided at remote control device 200, which may be external to track-mounted vehicle 100, as illustrated in FIG. 2. Remote control device 200 may comprise a server or other computing device located remote from track-mounted vehicle 100, for example at a remote operator station. Functionality of controller 112 may be provided at track-mounted vehicle 100, remote control device 200, or distributed between track-mounted vehicle 100 and remote control device 200. Information may be exchanged between controller 112 and track-mounted vehicle 100 over a data communication interface including any suitable wireless or wired connection. Examples of suitable communication interfaces are described with reference to FIG. 8.

Track-mounted vehicle 100 may comprise a positioning system comprising positioning device(s), for example a Global Positioning System (GPS) receiver(s), Global Navigation Satellite System (GNSS), other satellite positioning device(s), and/or a non-satellite positioning device(s). The positioning device(s) may be configured to determine a current navigation position of track-mounted vehicle 100. For example, a positioning device may be coupled to a particular part of track-mounted vehicle 100 and thereby configured to determine the position of that part of track-mounted vehicle 100 as the navigation position. Alternatively, controller 112 may be configured to determine the navigation position based on data received from multiple positioning devices of track-mounted vehicle 100, for example as the centre point of the positions detected by the positioning devices. The navigation position may therefore comprise a position of a certain reference point of track-mounted vehicle 100 in the external coordinate frame (Fₑₓₜ). The reference point may be referred to as a positioning reference point. The positioning reference point it may be located within track-mounted vehicle 100.

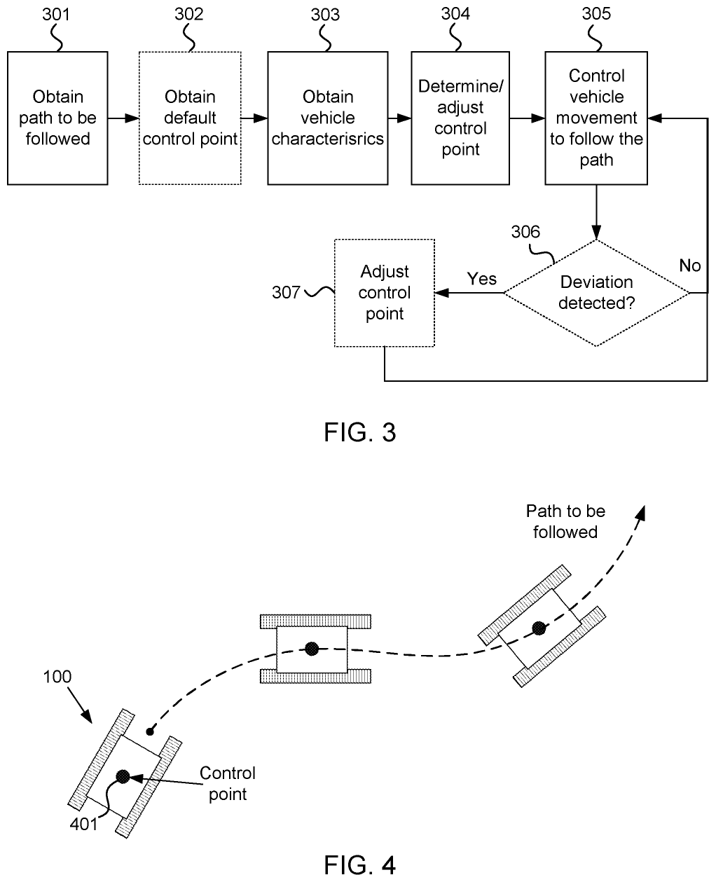

FIG. 3 illustrates an example of a flow chart for controlling a track-mounted vehicle. As described above, controller 112 may be configured to control track-mounted vehicle 100 locally or remotely via a communication interface. Controller 112 may comprise a user interface for enabling a human user to provide user input for controlling movement of track-mounted vehicle 100, for example to provide a desired path (route) for track-mounted vehicle 100.

At operation 301, controller 112 may be configured to obtain information on a path to be followed by track-mounted vehicle 100. Controller 112 may be configured to receive this information via the user interface, over a communication interface (e.g., from a remote server), or from a memory (e.g., a portable memory configured to be coupled to controller 112). An example of a path to be followed by track-mounted vehicle 100 is provided in FIG. 4. The path may be represented by a plurality of points in the external coordinate frame (Fₑₓₜ). The points may together define a desired path for track-mounted vehicle 100. However, any suitable representation of the path may be used. The information on the path to be followed may generally comprise a representation of the path in a coordinate system stationary with respect to ground. Controller 112 may be configured to control movement of track-mounted vehicle 100 such that control point 401 is aligned with the path, as will be further described with reference to operation 305.

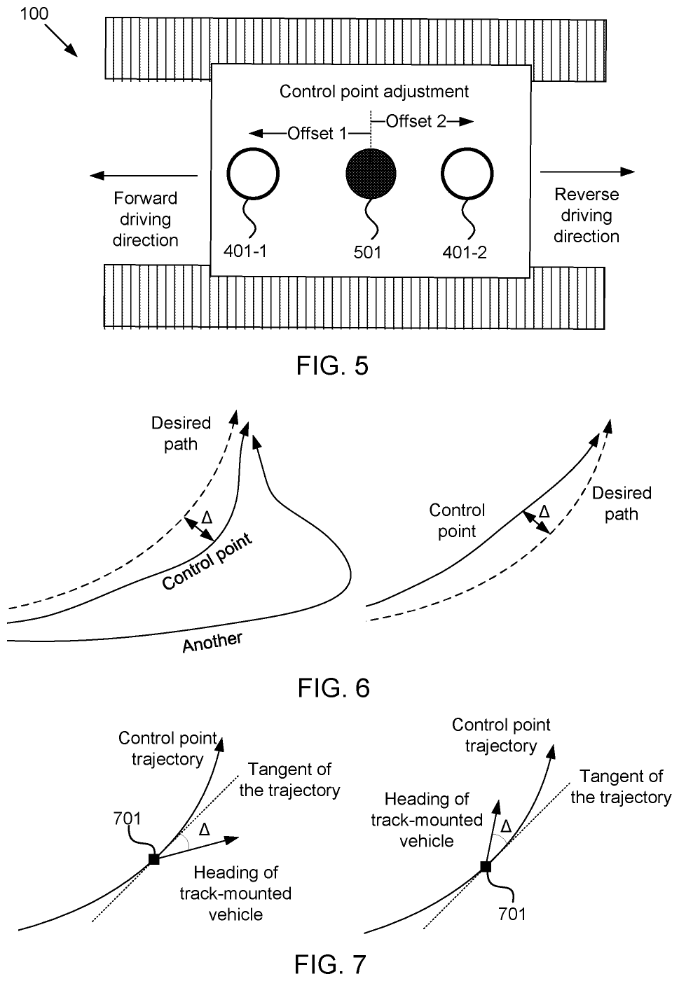

At operation 302, controller 112 may be configured to obtain a default control point for track-mounted vehicle 100. An example of a default control point is shown in FIG. 5. Default control point 501 may comprise pivot point 140, that is, the pivot point of track-mounted vehicle 100 without non-rotational transition of track-mounted vehicle 100 in the external coordinate frame (Fₑₓₜ). Position of default control point 501 may be defined in the coordinate frame of track-mounted vehicle 100 (F_{vehicle}), for example with respect to the positioning reference point of track-mounted vehicle 100 detected by the positioning system.

Position of default control point 501 may be preconfigured at memory of track-mounted vehicle 100 or remote control device 200. Controller 112 may be configured to obtain the position of default control point 501 by retrieving the position of default control point 501 from the memory. If controller 112 is located at remote control device 200, controller 112 may be configured to obtain default control point 501 by receiving it from track-mounted vehicle 100. Default control point 501 may be located within track-mounted vehicle 100. It is noted that obtaining default control point 501 may be optional. For example, controller 112 may be configured to determine control point 401 directly without using a default control point, as will be further described with reference to operation 304.

At operation 303, controller 112 may be configured to obtain vehicle characteristics, for example information on physical, operational or environmental characteristics, which affect movement control of track-mounted vehicle 100. For example, controller 112 may be configured to determine a physical or operational configuration of track-mounted vehicle 100, or current driving conditions of track-mounted vehicle 100. Physical characteristics affecting movement control of track-mounted vehicle 100 may comprise for example mass, current mast position, or current boom position of track-mounted vehicle 100. The operational characteristics may comprise for example driving direction of track-mounted vehicle 100, for example whether track-mounted vehicle 100 is moving, or is to be moved, in a forward or reverse driving direction. Environmental characteristics may comprise for example a type of current driving surface of track-mounted vehicle 100, for example whether the current driving surface is rock, sand, snow, or ice. The above characteristics affect the interaction between tracks 120 and the driving surface and therefore they may also affect movement control of track-mounted vehicle 100.

At operation 304, controller 112 may be configured to determine and/or adjust position of control point 401. Control point 401 may be configured to be aligned with the path to cause track-mounted vehicle 100 to follow the path. Therefore, the position of control point 401 in relation to track-mounted vehicle 100 affects how accurately track-mounted vehicle 100 follows the path. Control point 401 may be defined in the coordinate frame of track-mounted vehicle 100 (F_{vehicle}).

Controller 112 may be configured to determine/adjust the position of control point 401 based on at least one of the characteristics obtained at operation 303. This provides the benefit of improving movement control of track-mounted vehicle 100, because taking into account the characteristic(s) in determining position of control point 401 enables track-mounted vehicle 100 to be controlled to follow the path more accurately. The position of control point 401 may be in relation to track-mounted vehicle 100, for example in relation to the positioning reference point of track-mounted vehicle 100. The position of control point 401 may be within or outside track-mounted vehicle 100. Defining the position of control point 401 with respect to the positioning reference point enables to control movement of track-mounted vehicle 100 such that control point 401 is aligned with the path, because the location of the positioning reference point is tracked by the positioning system. In one example, default control point 501 is the same point as the positioning reference point.

As noted above, controller 112 may be configured to determine control point 401 directly, or by adjusting position of default control point 501. When controller 112 is configured to determine the control point directly, controller 112 may be configured to determine the position of control point 401 based on a mapping between the characteristic(s) obtained at operation 303 and positions of respective control points. This mapping may be preconfigured at controller 112 or received by controller 112 over a communication interface.

As an example of the mapping, a first position of control point 401 may be associated with a forward driving direction of track-mounted vehicle 100, or in general a first driving direction of track-mounted vehicle 100. A second (different) position of control point 401 may be associated with a reverse driving direction of track-mounted vehicle 100, or in general a second driving direction of track-mounted vehicle 100. When the first and second positions of control point 401 are associated with the forward and reverse driving directions, respectively, the first position may be located closer to the front of track-mounted vehicle 100 than the second position. For example, the first position may be located towards the front-end of track-mounted vehicle 100 from the centre of mass of track-mounted vehicle 100. The second position may be located towards the rear-end of track-mounted vehicle 100 from the centre of mass of track-mounted vehicle 100.

Controller 112 may be generally configured to adjust the position of the control point towards the driving direction (e.g., forward or backward) of track-mounted vehicle 100. This provides the benefit of more accurate movement control, as the adjustment of control point 401 to the driving direction reduces the deviation of the track-mounted vehicle 100 from the desired path.

Different inclination angles of mast 130 or boom(s) may be associated with respective positions of control point 401. Controller 112 may be configured to determine the current inclination angle based on sensor information measured by track-mounted vehicle 100, or based on control inputs provided by controller 112 for controlling the inclination angle. Controller 112 may be configured to determine the position of control point 401 based on the current inclination angle of mast 130 or a boom of track-mounted vehicle 100. Controller 112 may be for example configured to select a position of control point 401 by finding the control point position corresponding to the current inclination angle.

Different driving surfaces may be associated with respective positions of control point 401. Controller 112 may be configured to receive an indication of the type of the current driving surface, for example via a user interface. Controller 112 may be configured to determine the position of control point 401 based on a mapping between the different types of the current driving surface and respective positions of control point 401. Controller 112 may be for example configured to select a position of control point 401 by finding the control point position corresponding to the current driving surface (e.g., rock, sand, snow, or ice).

The mappings between the different physical, operational, or environmental characteristics and respective positions of control point 401 may be determined based on experimental data, obtained for example by observing movement of track-mounted vehicle 100 under respective configurations and/or conditions. The mapping(s) may be preconfigured (e.g., manually) at controller 112 or provided to controller 112 over a communication interface.

Controller 112 may be configured to determine the position of control point 401 based on a combination of different characteristics. For example, instead of respective positions of control point 401, individual characteristics may be mapped to respective positional offsets and the position of control point 401 may be determined as a combination of the positional offsets, for example starting from default control point 501, as will be further described with reference to FIG. 5.

FIG. 5 illustrates an example of adjusting position of a default control point.

Controller 112 may be configured to determine the position of control point 401 by adjusting the position of default control point 501 based on the characteristic(s) obtained at operation 303. For example, controller 112 may be configured to adjust the position of default control point 501 towards the driving direction of the track-mounted vehicle 100, in order to determine the position of the control point 401. For example, controller 112 may be configured to adjust the position of default control point 501 to obtain control point 401-1, if track-mounted vehicle 100 moves, or is to be moved, towards the forward driving direction. Controller 112 may be configured to adjust the position of default control point 501 to obtain control point 401-2, if track-mounted vehicle 100 moves, or is to be moved, towards the reverse driving direction.

Controller 112 may be configured to apply a first control point offset distance (Offset 1) to adjust the position of control point 401 from default control point 501 towards the forward driving direction, or in general a first driving direction. Controller 112 may be configured to apply a second control point offset distance (Offset 2) to adjust the position of control point 401 from default control point 501 to the reverse driving direction, or in general a second driving direction. The first control point offset distance may be different from second control point offset distance. This provides the benefit of taking into account different movement characteristics of track-mounted vehicle 100 during its movement to the different directions. Accuracy of movement control of track-mounted vehicle 100 may be therefore improved.

Controller 112 may be configured to adjust the position of default control point 501 based on the current inclination angle of mast 130 or a boom of track-mounted vehicle 100, in order to determine the position of control point 401. Controller 112 may be configured to determine a control point offset corresponding to the current inclination angle of mast 130 or the boom. Controller 112 may be configured to determine the control point offset based on a mapping between different inclination angles of mast 130 or the boom and respective control point offsets. Controller 112 may be configured to adjust the position of default control point 501 based on the determined control point offset. For example, controller 112 may be configured to adjust the position of default control point 501 to obtain either control point 401-1 or 401-2 depending on the current inclination angle. The mapping between the control point offsets may be preconfigured at controller 112 or received by controller 112 over a communication interface. The control point offset may comprise a positional offset, for example a vector in the coordinate frame of track-mounted vehicle 100 (F_{vehicle}).

As noted above, controller 112 may be configured to determine the position of control point 401 based on applying control point offsets (e.g., vectors in the coordinate frame of track-mounted vehicle 100) associated with multiple different characteristics. Applying default control point 501 therefore provides the benefit of enabling an offset-based determination of control point 401, possibly taking into account many of the characteristics obtained at operation 303. The mappings between the different physical, operational, or environmental characteristics and respective control point offsets may be determined based on experimental data, obtained for example by observing movement of track-mounted vehicle 100 under respective configurations and/or conditions. The mappings may be then preconfigured (e.g., manually) at memory of controller 112, track-mounted vehicle 100, or remote control device 200.

At operation 305, controller 112 may be configured to control movement of track-mounted vehicle 100 to follow the path obtained at 301. Controller 112 may be configured to control movement of track-mounted vehicle 100 based on the path and control point 401. Controller 112 may be configured to control movement of track-mounted vehicle 100 to align control point 401 with the path, as shown in FIG. 4. Aligning control point 401 with the path may comprise controlling movement of track-mounted vehicle 100 such that control point 401 coincides with the path or such that control point 401 is at a desired relative position with respect to the path (e.g., within a predetermined distance from the path), when track-mounted vehicle 100 moves along the path. Controller 112 may be therefore configured to cause track-mounted vehicle 100 to follow the path.

When controller 112 is located at track-mounted vehicle 100, controller 112 may be configured to control movement of track-mounted vehicle 100 by providing control instructions to movable carrier 110, in order to cause movement of track-mounted vehicle 100, e.g., by means of tracks 120. When controller 112 is located at remote control device 200, remote control device 200 may be configured control movement of track-mounted vehicle 100 by transmitting the control instructions provided by controller 112 to track-mounted vehicle 100, to cause the movement of track-mounted vehicle 100.

At operation 306, controller 112 may be configured to detect a deviation of the position of control point 401 from the path, or a deviation between the current heading of track-mounted vehicle 100 and a direction of a trajectory of control point 401. Controller 112 may be configured to detect the deviation at a turn of the trajectory. Controller 112 may be configured to determine whether the deviation is towards the inside of the turn or outside of the turn. If the turn is towards left, controller 112 may be configured to determine that a deviation to the left is towards the inside of the turn and that a deviation to the right is towards the outside of the turn. Controller 112 may be configured to determine a magnitude of the deviation, for example a distance of control point 401 from the path or the angle between the heading of track-mounted vehicle 100 and the direction of the trajectory. Controller 112 may be configured to determine the heading of track-mounted vehicle 100 based on previous locations of track-mounted vehicle 100 in the external coordinate frame (Fₑₓₜ) or based on orientation of track-mounted vehicle 100 in the external coordinate frame. The direction of the trajectory may comprise a tangent of the trajectory, for example at a point that is closest to the position of control point 401 in the external coordinate frame (Fₑₓₜ).

At operation 307 controller 112 may be configured to adjust the position of control point 401 based on the detected deviation, for example the direction and/or magnitude of the deviation. Controller 112 may be configured to determine a direction of the adjustment based on the direction of the deviation, e.g., based on at which side of the path the deviation occurs. For example, if controller 112 detects the deviation to be towards the inside of the turn, controller 112 may be configured to adjust the position of control point 401 opposite to the driving direction. If controller 112 detects the deviation to be towards the outside of the turn, controller 112 may be configured to adjust the position of control point 401 to the driving direction. The distance of the adjustment (cf. “offset” of FIG. 5) may be proportional to the magnitude of the deviation, for example the distance between control point 401 and the path. Controller 112 may be configured to calculate the deviation for multiple points along the frame of track-mounted vehicle 100 to determine adjustment.

As described above, controller 112 may be alternatively, or additionally, configured to detect a deviation between the heading of track-mounted vehicle 100 and the direction of the trajectory of control point 401. Controller 112 may be configured to record positions of control point 401 during movement of track-mounted vehicle 100 in order to determine the trajectory of control point 401. Controller 112 may be configured to adjust the position of control point 401 based on the deviation between the heading of track-mounted vehicle 100 and the direction of the trajectory of control point 401 at one or more points on the trajectory, for example at point 701. Controller 112 may be configured to select a point on the trajectory, determine a tangent of the trajectory at the selected point as the direction of the trajectory, and compare the heading of track-mounted vehicle 100 at the selected point to the direction of the tangent at the selected point.

Controller 112 may be configured to adjust the position of control point 401 opposite to the driving direction of track-mounted vehicle 100, in response to detecting that the deviation of the heading of track-mounted vehicle 100 from the direction of the trajectory is towards inside of the turn of the trajectory of control point 401. Controller 112 may be configured to adjust the position of control point 401 towards to the driving direction of track-mounted vehicle 100, in response to detecting that the deviation of the heading of track-mounted vehicle 100 from the direction of the trajectory is towards outside of the turn of the trajectory. Distance of the adjustment (cf. “offset” of FIG. 5) may be proportional to magnitude of the deviation, in this example the angle of deviation between the heading of track-mounted vehicle 100 and the direction of the trajectory. Monitoring the deviation(s) enables dynamic adjustment of the position of control point 401, thereby improving movement control of track-mounted vehicle 100 during its movement.

Controller 112 may be configured to calculate headings (motion advancement directions) of a plurality of control points of track-mounted vehicle 100, for example over a control period. Controller 112 may be configured to determine the positions of the plurality of control points based on outputs of the positioning devices of track-mounted vehicle 100. The plurality of control points may be located at positions of respective positioning devices. Controller 112 may be configured to determine or adjust the position of control point 401 (i.e., the control point used for controlling movement of track-mounted vehicle 100) based on errors (differences) among the headings of the plurality of control points. Controller 112 may be configured to determine a combined heading error for the plurality of control points, for example based on determining an average heading of the plurality of control points. Controller 112 may be configured to determine the heading error among the headings of the plurality of control points based on deviations between the headings of the plurality of control points and their average. Controller 112 may be configured to adjust the position of control point 401 based on the combined heading error, for example as described above. For example, controller 112 may be configured to adjust the position of control point 401 opposite to the driving direction, in response to detecting the heading error to be towards the inside of the turn, and vice versa. This reduces the error among the headings of the plurality of control points and the deviation of track-mounted vehicle 100 from the desired path. Controller 112 may be configured to monitor the error in the headings of the plurality of control points and to dynamically adjust the position of the control point to minimize the error. In other words, controller 112 may be configured to determine the position of control point 401 by determining the point that gives the minimum distance error against average motion advancement direction.

It is further noted that any methods for determining the deviation or error between intended and observed positions of control point 401, heading of track-mounted vehicle 100 and direction of the trajectory of control point 401, or headings of the positioning-based control point locations and track-mounted vehicle 100, may be applied over a time period (e.g., averaged over the control period). This provides the benefit of improving movement control of track-mounted vehicle 100 in presence of noisy positioning data.

The example operations of FIG. 3 provide the benefit of improving movement control of track-mounted vehicle 100. Even though particular sequence of operations is illustrated in FIG. 3, it is understood that the operations may be executed in any suitable order and that some operations might not be present in some example embodiments. For example, operations 302, 306, and 307 may be optional.

FIG. 6 illustrates examples of deviations (A) between control point 401 and the desired path (dashed line). On the left, the deviation is towards the outside of the turn. Controller 112 may be therefore configured to adjust the position of control point 401, at the coordinate frame of track-mounted vehicle 100 (F′vehicle), towards the driving direction. It is noted that even a relatively small deviation between control point 401 and the desired path may cause a relatively large deviation of another point (e.g., rear-end) of track-mounted vehicle 100 from the desired path, as illustrated on the left. On the right, the deviation is towards the inside of the turn. Controller 112 may be therefore configured to adjust the position of control point 401 opposite to the driving direction.

FIG. 7 illustrates an example of deviation of the heading of a track-mounted vehicle 100 from the trajectory of the control point of track-mounted vehicle 100. The deviation (4) may comprise an angle between the heading of track-mounted vehicle 100 and the direction of the trajectory of control point 401, represented by the tangent of the trajectory. On the left, the deviation is again towards the outside of the turn. Controller 112 may be therefore configured to adjust the position of control point 401 towards the driving direction. On the right, the deviation is towards the inside of the turn. Controller 112 may be therefore configured to adjust the position of control point 401 opposite to the driving direction.

FIG. 8 illustrates an example of an apparatus configured to practise one or more example embodiments. Apparatus 800 may be or comprise a track-mounted vehicle control apparatus, such as for example a server communicatively coupled to track-mounted vehicle 100, a control apparatus located at track-mounted vehicle 100, controller 112, track-mounted vehicle 100 itself, or in general any device or system configured to implement the functionality described herein. Although apparatus 800 is illustrated as a single device, it is appreciated that, wherever applicable, functions of apparatus 800 may be distributed to a plurality of devices.

Apparatus 800 may comprise at least one processor 802. The at least one processor 802 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 800 may further comprise at least one memory 804. The at least one memory 804 may be configured to store, for example, computer program code or the like, for example operating system software and application software. The at least one memory 804 may comprise one or more volatile memory devices, one or more non-volatile memory devices, and/or a combination thereof. For example, the memory may be embodied as magnetic storage devices (such as hard disk drives, etc.), optical magnetic storage devices, or semiconductor memories (such as mask ROM, PROM (programmable ROM), EPROM (erasable PROM), flash ROM, RAM (random access memory), etc.). Memory 804 is provided as an example of a (non-transitory) computer readable medium. The term “non-transitory,” as used herein, is a limitation of the medium itself (i.e., tangible, not a signal) as opposed to a limitation on data storage persistency (e.g., RAM vs. ROM). The at least one memory 804 may be also embodied separate from apparatus 800, for example as a computer readable (storage) medium, examples of which include memory sticks, compact discs (CD), or the like.

When apparatus 800 is configured to implement some functionality, some component and/or components of apparatus 800, such as for example the at least one processor 802 and/or the at least one memory 804, may be configured to implement this functionality. Furthermore, when the at least one processor 802 is configured to implement some functionality, this functionality may be implemented using program code 806 comprised, for example, in the at least one memory 804.

The functionality described herein may be performed, at least in part, by one or more computer program product components such as software components. According to an example embodiment, apparatus 800 comprises a processor or processor circuitry, such as for example a microcontroller, configured by program code 806, when executed, to execute the embodiments of the operations and functionality described herein. Program code 806 is provided as an example of instructions which, when executed by the at least one processor 802, cause performance of apparatus 800.

For example, controller 112 may be at least partially implemented as program code configured to cause apparatus 800 to perform functionality of controller 112. Similarly, transmission or reception of data, e.g., sensor data or command(s), over an internal or external communication interface of track-mounted vehicle 100 may be controlled by software.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), neural processing unit (NPU), tensor processing unit (TPU), or the like.

Apparatus 800 may comprise a communication interface 808 configured to enable apparatus 800 to transmit and/or receive information. Communication interface 808 may comprise an internal or external communication interface, such as for example a radio interface between track-mounted vehicle 100 and controller 112 or an internal control bus within track-mounted vehicle 100. Apparatus 800 may further comprise other components and/or functions such as for example a user interface (not shown) comprising at least one input device and/or at least one output device. The input device may take various forms such as a keyboard, a touch screen, or one or more embedded control buttons, joysticks, or other type of manual controllers. The output device may for example comprise a display, a speaker, or the like. User interface may be configured to enable a human operator to monitor various functions, data, or the like.

Apparatus 800 may be configured to perform or cause performance of any aspect of the method(s) described herein. Further, a computer program or a computer program product may comprise instructions for causing, when executed by apparatus 800, apparatus 800 to perform any aspect of the method(s) described herein. Further, apparatus 800 may comprise means for performing any aspect of the method(s) described herein. In one example, the means comprises the at least one processor 802, the at least one memory 804 including program code 806 (instructions) configured to, when executed by the at least one processor 802, cause apparatus 800 to perform the method(s). In general, computer program instructions may be executed on means providing generic processing functions. Such means may be embedded for example in a computer, a server, or the like. The method(s) may be thus computer-implemented, for example based algorithm(s) executable by the generic processing functions, an example of which is the at least one processor 802. Apparatus 800 may comprise means for transmitting or receiving information, for example one or more wired or wireless (e.g. radio) transmitters or receivers, which may be coupled or be configured to be coupled to one or more antennas, or transmitter(s) or receiver(s) of a wired communication interface.

According to a first aspect, an apparatus for controlling track-mounted vehicle is disclosed. The apparatus may comprise: at least one processor; and at least one memory including computer program code, the at least one memory and the computer program code configured to, with the at least one processor, cause the apparatus at least to: obtain information on a path to be followed by the track-mounted vehicle: obtain information on at least one characteristic affecting movement control of the track-mounted vehicle; determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path.

According to an example embodiment of the first aspect, the at least one characteristic comprises a physical characteristic of the track-mounted vehicle, an operational characteristic of the track-mounted vehicle, and/or an environmental characteristic of the track-mounted vehicle.

According to an example embodiment of the first aspect, the physical characteristic of the track-mounted vehicle comprises a mass, a mast position, or a boom position of the track-mounted vehicle, wherein the operational characteristic comprises a driving direction of the track-mounted vehicle, or wherein the environmental characteristic comprises a type of a current driving surface of the track-mounted vehicle.

According to an example embodiment of the first aspect, the computer program code is further configured to, with the at least one processor, cause the apparatus to: adjust the position of the control point towards the driving direction of the track-mounted vehicle.

According to an example embodiment of the first aspect, the computer program code is further configured to, with the at least one processor, cause the apparatus to: determine the position of the control point based on a current inclination angle of a mast or a boom of the track-mounted vehicle.

According to an example embodiment of the first aspect, the computer program code is further configured to, with the at least one processor, cause the apparatus to: obtain a default control point, wherein the default control point comprises a pivot point of the track-mounted vehicle without non-rotational transition of the track-mounted vehicle in a coordinate system; and determine the position of the control point by adjusting a position of the default control point based on the at least one characteristic.

According to an example embodiment of the first aspect, the computer program code is further configured to, with the at least one processor, cause the apparatus to: adjust the position of the default control point towards a driving direction of the track-mounted vehicle to determine the position of the control point, and/or adjust the position of the default control point based on a current inclination angle of a mast or a boom of the track-mounted vehicle to determine the position of the control point.

According to an example embodiment of the first aspect, the computer program code is further configured to, with the at least one processor, cause the apparatus to: apply a first control point offset distance to adjust the position of the default control point towards a first driving direction of the track-mounted vehicle; and apply a second control point offset distance to adjust the position of the default control point towards a second driving direction of the track-mounted vehicle, wherein the first control point offset distance is different from the second control point offset distance.

According to an example embodiment of the first aspect, the computer program code is further configured to, with the at least one processor, cause the apparatus to: determine a control point offset for the current inclination angle of the mast or the boom based on a mapping between a plurality of inclination angles of the mast or the boom and respective control point offsets; and adjust the position of the default control point based on the control point offset.

According to an example embodiment of the first aspect, the computer program code is further configured to, with the at least one processor, cause the apparatus to: detect a deviation of the position of the control point from the path at a turn of the path; and adjust the position of the control point opposite to the driving direction of the track-mounted vehicle, in response to determining that the deviation is towards inside of the turn of the path, or adjust the control point towards the driving direction of the track-mounted vehicle, in response to determining that the deviation is towards outside of the turn of the path.

According to an example embodiment of the first aspect, the computer program code is further configured to, with the at least one processor, cause the apparatus to: detect a deviation between a heading of the track-mounted vehicle and a tangent of a trajectory of the control point; and adjust the position of the control point based on the deviation between the heading of the track-mounted vehicle and the tangent of the trajectory of the control point.

According to an example embodiment of the first aspect, the apparatus is external to the track-mounted vehicle and configured to remotely control the track-mounted vehicle.

According to a second aspect, a track-mounted vehicle is disclosed. The track-mounted vehicle may comprise: at least one processor; and at least one memory including computer program code, the at least one memory and the computer program code configured to, with the at least one processor, cause the track-mounted vehicle at least to: obtain information on a path to be followed by the track-mounted vehicle: obtain information on at least one characteristic affecting movement control of the track-mounted vehicle: determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path. The computer program code may be configured to, with the at least one processor, cause the track-mounted vehicle to perform any example embodiments of the apparatus of the first aspect.

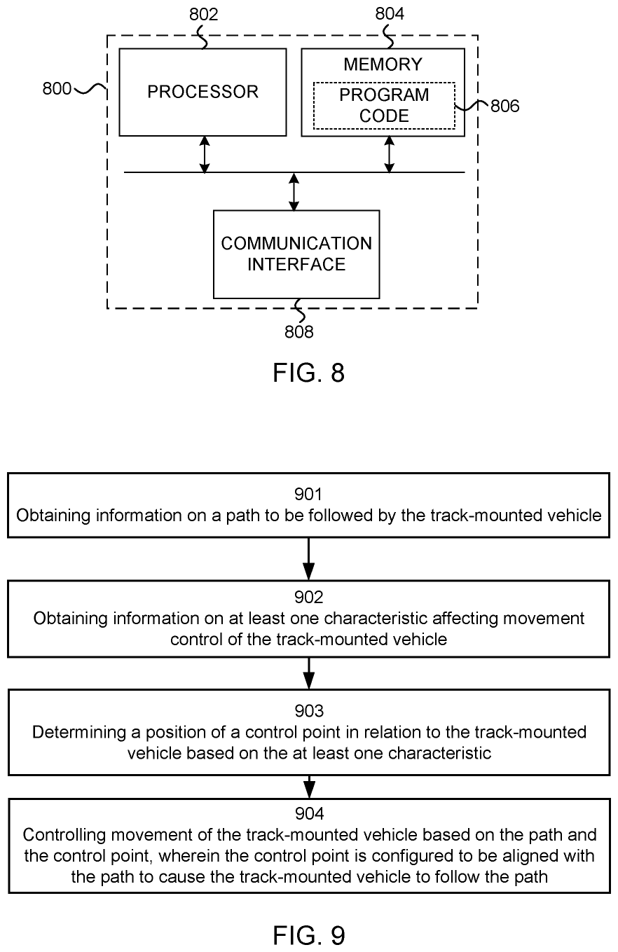

FIG. 9 illustrates an example of a method for controlling a track-mounted vehicle, according to a third aspect of the present disclosure. The method may comprise a computer-implemented method performed by, for example, apparatus 800 such as controller 112.

At 901, the method may comprise obtaining information on a path to be followed by the track-mounted vehicle.

At 902, the method may comprise obtaining information on at least one characteristic affecting movement control of the track-mounted vehicle.

At 903, the method may comprise determining a position of a control point in relation to the track-mounted vehicle based on the at least one characteristic.

At 904, the method may comprise controlling movement of the track-mounted vehicle based on the path and the control point, wherein the control point is configured to be aligned with the path to cause the track-mounted vehicle to follow the path

According to an example embodiment of the third aspect, the at least one characteristic comprises a physical characteristic of the track-mounted vehicle, an operational characteristic of the track-mounted vehicle, and/or an environmental characteristic of the track-mounted vehicle.

According to an example embodiment of the third aspect, the physical characteristic of the track-mounted vehicle comprises a mass, a mast position, or a boom position of the track-mounted vehicle, wherein the operational characteristic comprises a driving direction of the track-mounted vehicle, or wherein the environmental characteristic comprises a type of a current driving surface of the track-mounted vehicle.

According to an example embodiment of the third aspect, the method may comprise: adjusting the position of the control point towards the driving direction of the track-mounted vehicle.

According to an example embodiment of the third aspect, the method may comprise: determining the position of the control point based on a current inclination angle of a mast or a boom of the track-mounted vehicle.

According to an example embodiment of the third aspect, the method may comprise: obtaining a default control point, wherein the default control point comprises a pivot point of the track-mounted vehicle without non-rotational transition of the track-mounted vehicle in a coordinate system; and determining the position of the control point by adjusting a position of the default control point based on the at least one characteristic.

According to an example embodiment of the third aspect, the method may comprise: adjusting the position of the default control point towards a driving direction of the track-mounted vehicle to determine the position of the control point, and/or adjusting the position of the default control point based on a current inclination angle of a mast or a boom of the track-mounted vehicle to determine the position of the control point.

According to an example embodiment of the third aspect, the method may comprise: applying a first control point offset distance to adjust the position of the default control point towards a first driving direction of the track-mounted vehicle; and applying a second control point offset distance to adjust the position of the default control point towards a second driving direction of the track-mounted vehicle, wherein the first control point offset distance is different from the second control point offset distance.

According to an example embodiment of the third aspect, the method may comprise: determining a control point offset for the current inclination angle of the mast or the boom based on a mapping between a plurality of inclination angles of the mast or the boom and respective control point offsets; and adjusting the position of the default control point based on the control point offset.

According to an example embodiment of the third aspect, the method may comprise: detecting a deviation of the position of the control point from the path at a turn of the path; and adjusting the position of the control point opposite to the driving direction of the track-mounted vehicle, in response to determining that the deviation is towards inside of the turn of the path, or adjusting the control point towards the driving direction of the track-mounted vehicle, in response to determining that the deviation is towards outside of the turn of the path.

According to an example embodiment of the third aspect, the method may comprise: detecting a deviation between a heading of the track-mounted vehicle and a tangent of a trajectory of the control point; and adjusting the position of the control point based on the deviation between the heading of the track-mounted vehicle and the tangent of the trajectory of the control point.

According to an example embodiment of the third aspect, the apparatus is external to the track-mounted vehicle and configured to remotely control the track-mounted vehicle.

According to a fourth aspect, an apparatus may comprise means for means for obtaining information on a path to be followed by the track-mounted vehicle: means for obtaining information on at least one characteristic affecting movement control of the track-mounted vehicle: means for determining a position of a control point in relation to the track-mounted vehicle based on the at least one characteristic; and means for controlling movement of the track-mounted vehicle based on the path and the control point, wherein the control point is configured to be aligned with the path to cause the track-mounted vehicle to follow the path. The apparatus may comprise means for performing any example embodiment of the method of the third aspect.

According to a fifth aspect, a computer program, a computer program product, or a (non-transitory) computer-readable medium may comprise program instructions which, when executed by an apparatus, cause the apparatus at least to: obtain information on a path to be followed by the track-mounted vehicle: obtain information on at least one characteristic affecting movement control of the track-mounted vehicle: determine a position of a control point in relation to the track-mounted vehicle based on the at least one characteristic; and control movement of the track-mounted vehicle based on the path and the control point, wherein the control point is configured to be aligned with the path to cause the track-mounted vehicle to follow the path. The computer program, the computer program product, or the (non-transitory) computer-readable medium may comprise program instructions which, when executed by an apparatus, cause the apparatus to perform any example embodiment of the method of the third aspect.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. Term “or” may be understood to also cover a case where both of the items separated by “or” are included. Hence, “or” may be understood as an inclusive “or” rather than an exclusive “or”.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus for controlling a track-mounted vehicle, the apparatus comprising:
at least one processor; and
at least one memory including computer program code, the at least one memory and the computer program code configured to, with the at least one processor, cause the apparatus at least to:
obtain information on a path to be followed by the track-mounted vehicle;
obtain information on at least one characteristic affecting movement control of the track-mounted vehicle;
determine a position of a control point in relation to the track-mounted vehicle based on the at least one characteristic; and
control movement of the track-mounted vehicle based on the path and the control point, wherein the control point is configured to be aligned with the path to cause the track-mounted vehicle to follow the path.

2. The apparatus according to claim 1, wherein the at least one characteristic comprises a physical characteristic of the track-mounted vehicle, an operational characteristic of the track-mounted vehicle, and/or an environmental characteristic of the track-mounted vehicle.

3. The apparatus according to claim 2, wherein the physical characteristic of the track-mounted vehicle comprises a mass, a mast position, or a boom position of the track-mounted vehicle, wherein the operational characteristic comprises a driving direction of the track-mounted vehicle, or wherein the environmental characteristic comprises a type of a current driving surface of the track-mounted vehicle.

4. The apparatus according to claim 3, wherein the computer program code is further configured to, with the at least one processor, cause the apparatus to:
adjust the position of the control point towards the driving direction of the track-mounted vehicle.

5. The apparatus according to claim 1, wherein the computer program code is further configured to, with the at least one processor, cause the apparatus to:
determine the position of the control point based on a current inclination angle of a mast or a boom of the track-mounted vehicle.

6. The apparatus according to claim 1, wherein the computer program code is further configured to, with the at least one processor, cause the apparatus to:
obtain a default control point, wherein the default control point comprises a pivot point of the track-mounted vehicle without non-rotational transition of the track-mounted vehicle in a coordinate system; and
determine the position of the control point by adjusting a position of the default control point based on the at least one characteristic.

7. The apparatus according to claim 6, wherein the computer program code is further configured to, with the at least one processor, cause the apparatus to:
adjust the position of the default control point towards a driving direction of the track-mounted vehicle to determine the position of the control point, and/or
adjust the position of the default control point based on a current inclination angle of a mast or a boom of the track-mounted vehicle to determine the position of the control point.

8. The apparatus according to claim 7, wherein the computer program code is further configured to, with the at least one processor, cause the apparatus to:
apply a first control point offset distance to adjust the position of the default control point towards a first driving direction of the track-mounted vehicle; and
apply a second control point offset distance to adjust the position of the default control point towards a second driving direction of the track-mounted vehicle, wherein the first control point offset distance is different from the second control point offset distance.

9. The apparatus according to claim 7, wherein the computer program code is further configured to, with the at least one processor, cause the apparatus to:
determine a control point offset for the current inclination angle of the mast or the boom based on a mapping between a plurality of inclination angles of the mast or the boom and respective control point offsets; and
adjust the position of the default control point based on the control point offset.

10. The apparatus according to claim 1, wherein the computer program code is further configured to, with the at least one processor, cause the apparatus to:
detect a deviation of the position of the control point from the path at a turn of the path; and
adjust the position of the control point opposite to the driving direction of the track-mounted vehicle, in response to determining that the deviation is towards inside of the turn of the path, or
adjust the control point towards the driving direction of the track-mounted vehicle, in response to determining that the deviation is towards outside of the turn of the path.

11. The apparatus according to claim 1, wherein the computer program code is further configured to, with the at least one processor, cause the apparatus to:
detect a deviation between a heading of the track-mounted vehicle and a tangent of a trajectory the control point; and
adjust the position of the control point based on the deviation between the heading of the track-mounted vehicle point and the tangent of the trajectory of the control point.

12. The apparatus according to claim 1, wherein the apparatus is external to the track-mounted vehicle and configured to remotely control the track-mounted vehicle.

13. A track-mounted vehicle comprising the apparatus according to claim 1.

14. A method for controlling a track-mounted vehicle, comprising:
obtaining information on a path to be followed by the track-mounted vehicle;
obtaining information on at least one characteristic affecting movement control of the track-mounted vehicle;
determining a position of a control point in relation to the track-mounted vehicle based on the at least one characteristic; and
controlling movement of the track-mounted vehicle based on the path and the control point, wherein the control point is configured to be aligned with the path to cause the track-mounted vehicle to follow the path.

15. The method according to claim 14, wherein the at least one characteristic comprises a physical characteristic of the track-mounted vehicle, an operational characteristic of the track-mounted vehicle, and/or an environmental characteristic of the track-mounted vehicle.

16. The method according to claim 15, wherein the physical characteristic of the track-mounted vehicle comprises a mass, a mast position, or a boom position of the track-mounted vehicle, wherein the operational characteristic comprises a driving direction of the track-mounted vehicle, or wherein the environmental characteristic comprises a type of a current driving surface of the track-mounted vehicle.

17. The method according to claim 16, wherein the computer program code is further configured to, with the at least one processor, cause the apparatus to adjust the position of the control point towards the driving direction of the track-mounted vehicle.

18. The method according to claim 14, further comprising determining the position of the control point based on a current inclination angle of a mast or a boom of the track-mounted vehicle.

19. The method according to claim 14, further comprising:
obtaining a default control point, wherein the default control point comprises a pivot point of the track-mounted vehicle without non-rotational transition of the track-mounted vehicle in a coordinate system; and
determining the position of the control point by adjusting a position of the default control point based on the at least one characteristic.

20. A non-transitory computer readable medium comprising program instructions which, when executed by an apparatus, cause the apparatus at least to:
obtain information on a path to be followed by the track-mounted vehicle;
obtain information on at least one characteristic affecting movement control of the track-mounted vehicle;
determine a position of a control point in relation to the track-mounted vehicle based on the at least one characteristic; and
control movement of the track-mounted vehicle based on the path and the control point, wherein the control point is configured to be aligned with the path to cause the track-mounted vehicle to follow the path.
